(19) United States
(12) Patent Application Publication
(10) Pub. No.: US 2024/0085204 A1
(43) Pub. Date: Mar. 14, 2024

(54) System and Method for Preparing a Hybrid Electric Vehicle for Operation in a Geographic Zone with an Operational Requirement

(71) Applicant: Hyliion Inc., Cedar Park, TX (US)

(72) Inventors: Moustapha Diab, Austin, TX (US); Ryan Wostarek, Pflugerville, TX (US); William Clements, Salado, TX (US)

(21) Appl. No.: 18/447,727

(22) Filed: Aug. 10, 2023

Related U.S. Application Data
(60) Provisional application No. 63/405,012, filed on Sep. 9, 2022.

(51) Int. Cl. G01C 21/34; B60L 7/10; B60L 58/13; G01C 21/36

(52) U.S. Cl. CPC G01C 21/3469; B60L 7/10; B60L 58/13; G01C 21/3461; G01C 21/3691; B60L 2200/36; B60L 2240/26; B60L 2240/64; B60L 2240/66; B60L 2240/68; B60L 2260/52; B60L 2260/54

(57) ABSTRACT

Systems and methods of preparing a vehicle for operation in a geographic zone having an operational requirement are disclosed that include determining a route for the vehicle, determining whether a geographic zone having an operational requirement exists on the route, and determining a powertrain configuration that includes a minimum state of charge (SoC) for a battery system of the vehicle based on the route data, the vehicle data, and/or the external data. The minimum SoC ensures that the vehicle can travel through the geographic zone while complying with the operational requirement. The systems and methods disclosed herein also include identifying a preparation zone for each geographic zone having an operational requirement and operating the vehicle through the preparation zone to ensure the battery system achieves the minimum SoC prior to entering the geographic zone having the operational requirement.

### BENEFIT CLAIM

This application claims the benefit under 35 U.S.C. 119(e) of provisional application 63/405,012, filed Sep. 9, 2022, the entire contents of which is hereby incorporated by reference for all purposes as if fully set forth herein.

### BACKGROUND

Many jurisdictions have introduced so-called “green energy” initiatives designed to reduce greenhouse gas emissions produced by traditional fuel-powered vehicles. To promote these initiatives, some geographic areas (e.g., cities and environmentally sensitive areas) have specific vehicle operational requirements, such as noise restrictions and no exhaust emissions (electric vehicle “EV” only mode) requirements throughout the city or environmentally sensitive area. However, traditional hybrid electric vehicles do not prepare the vehicle systems for operation in these areas and require manual operation to ensure compliance, which limits the vehicle's range and exposes the risk of non-compliance through human error.

### BRIEF DESCRIPTION OF THE DRAWINGS

For a more complete understanding of the present disclosure and so that the features and advantages of the embodiments can be understood in more detail, reference is now made to the following brief description, taken in connection with the accompanying drawings and detailed description.

FIG. 1 shows a schematic side view of a vehicle according to an embodiment of the disclosure.

FIG. 2 shows a schematic diagram of an example route comprising a geographic zone having an operational requirement according to an embodiment of the disclosure.

FIG. 3 shows a graph of an example charging strategy for a battery system of the vehicle according to an embodiment of the disclosure.

FIG. 4 shows a flowchart of a method of operating a vehicle according to an embodiment of the disclosure.

### DETAILED DESCRIPTION

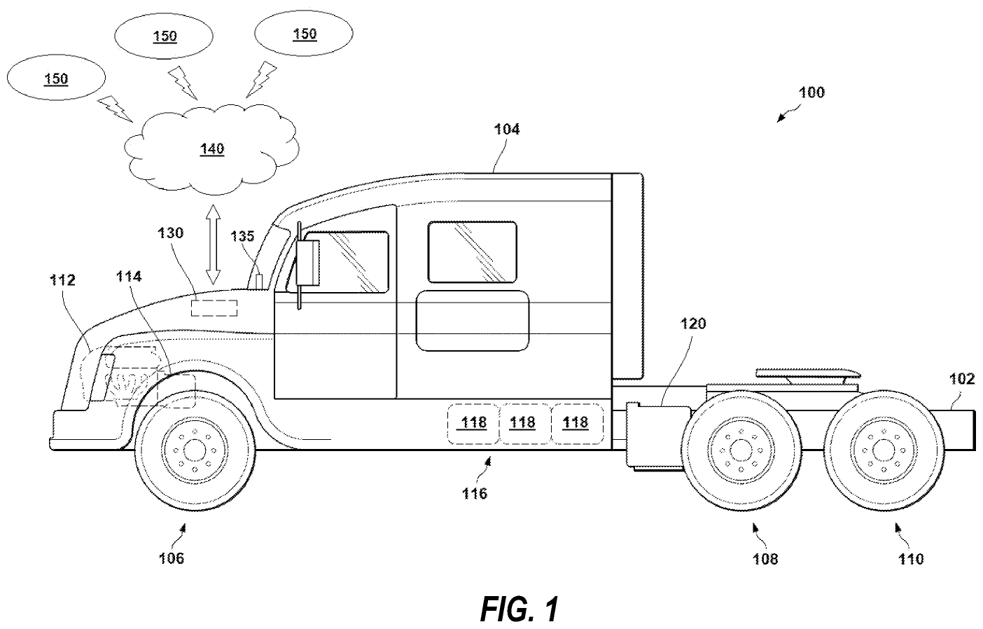

FIG. 1 shows a schematic side view of a vehicle according to an embodiment of the disclosure. In an embodiment, certain components are implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of preparing systems of vehicles to operate in geographic areas with specific vehicle operational requirements, such as noise restrictions and no exhaust emissions. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In some embodiments, the vehicle 100 may comprise a truck or a truck/trailer combination. The vehicle 100 may comprise a chassis 102 comprising a plurality of frame rails, a cab 104 supported by the chassis 102, a front wheeled steering axle 106 coupled to the chassis 102, and one or more rear drive axles 108, 110 coupled to the chassis 102. The vehicle 100 may also comprise a fuel fed engine 112 coupled to a first motor/generator (M/G) 114 and configured to burn one or more fuels (e.g., natural gas, diesel, hydrogen, liquified petroleum gas, etc.) to provide rotational power to the first M/G 114 to generate electrical power. The vehicle 100 may also comprise a battery system 116 comprising one or more battery packs 118. The battery packs 118 may be electrically coupled in parallel, series, or a combination thereof depending on the application, configuration, and/or power or voltage requirements of the vehicle 100. The battery system 116 may be coupled to the first M/G 114 and configured to receive and store electrical power generated by the first M/G 114. The vehicle 100 may also comprise a second M/G 120 coupled to the one or more drive axles 108, 110. Electrical power from the battery system 116 may be selectively supplied to the second M/G 120 to provide a motive torque through the one or more drive axles 108, 110 to propel the vehicle 100 over the route. Further, in some embodiments, the battery system 116 may also receive electrical power generated by the second M/G 120 through the one or more drive axles 108, 110 in a regenerative braking mode to recover rotational energy from the one or more drive axles 108, 110 and charge the one or more battery packs 118 of the battery system 116.

The vehicle 100 may also comprise a control system 130 that may execute instructions to control operation of the vehicle 100. In some embodiments, the control system 130 may comprise one or more system controllers that are communicatively coupled. For example, in some embodiments, the control system 130 may comprise a main control unit, a drive processing unit, and a gateway therebetween. In some embodiments, the control system 130 may comprise one or more databases configured to receive and store vehicle data (e.g., terrain database that stores terrain data). In some embodiments, the control system 130 may also comprise a user interface 135 that may accept user (e.g., driver) inputs (e.g., a route) that may be communicated to the main control unit, the drive processing unit, or a combination thereof, where the user inputs may be used to influence control and/or operation of the vehicle 100. In some embodiments, the control system 130 may be configured to collect vehicle data from the various components, sensors, or systems of the vehicle 100. In some embodiments, the control system 130 may be configured to communicate with a battery management controller of the battery system 116 to selectively control an amount of the electrical power supplied from the battery system 116 to the second M/G 120 to control operation of the vehicle 100.

In some embodiments, the control system 130 may be configured to collect vehicle data from the vehicle 100, retrieve stored vehicle data from a database, and/or receive user inputs of vehicle data made through the user interface 135 in the cab 104 of the vehicle 100. In some embodiments, the vehicle data may comprise a current location of the vehicle 100, a speed of the vehicle 100, load information of the vehicle 100, a planned destination for the vehicle 100, a route of the vehicle 100, a state of charge (SoC) of the battery system 116 of the vehicle 100, a grade of road on which the vehicle 100 is travelling, terrain data associated with the route of the vehicle 100, geographic information associated with the route of the vehicle 100, ordinances or regulations associated with the route of the vehicle 100, a fuel level, or any combination thereof. In some embodiments, the control system 130 may comprise a controller area network (“CANBUS”) or other communication means for communicating the vehicle data wirelessly over a network with an external network system or cloud computing system (the “cloud”) 140. In some embodiments, the control system 130 may be configured to communicate the vehicle data continuously to the cloud computing system 140. Further, in some embodiments, the control system 130 may receive data from the cloud computing system 140 for use locally on the vehicle 100.

The cloud computing system 140 may generally be connected in wireless communication with the control system 130 and be configured to wirelessly receive and/or retrieve the vehicle data from the control system 130. In some embodiments, the cloud computing system 140 may also be connected in wireless communication with one or more external data sources 150. The cloud computing system 140 may be configured to selectively receive and/or retrieve external data from the one or more external data sources 150. In some embodiments, the external data may comprise a grade of each portion of the route of the vehicle 100, road conditions of the route of the vehicle 100, weather data associated with the route of the vehicle 100, geographic information associated with the route of the vehicle 100, ordinances or regulations associated with the route of the vehicle 100, traffic information associated with the route of the vehicle 100, or any combination thereof. In some embodiments, the cloud computing system 140 may comprise a private external server configured to collect and store the vehicle data and the external data for a plurality of vehicles. Further, in some embodiments, the cloud computing system 140 may communicate the external data to the control system 130 for use locally on the vehicle 100.

In operation, the control system 130 and/or the cloud computing system 140 may be configured to determine whether a geographic region or zone having an operational requirement exists on the route of the vehicle 100. In some embodiments, the determination of whether a geographic zone having an operational requirement exists on the route of the vehicle 100 may be based on the vehicle data (e.g., the route of the vehicle 100) and/or the external data (e.g., the geographic information associated with the route of the vehicle 100 and/or ordinances or regulations associated with a geographic zone on the route of the vehicle 100). In some embodiments, the determination of whether a geographic zone having an operational requirement exists on the route of the vehicle 100 may occur as the vehicle 100 travels over the route (e.g., in response to route changes, exits, detours, etc.). In some embodiments, the determination of whether a geographic zone having an operational requirement exists on the route of the vehicle 100 may occur prior to the vehicle 100 beginning to travel over the route.

In some embodiments, the geographic zone may require a mandatory operational requirement that may be imposed by a municipality or other governing body. In some embodiments, the geographic zone may comprise a zero emissions (electric vehicle “EV” zone) operational requirement. Such zero emissions operational requirements may restrict the ability to operate the fuel fed engine 112 of the vehicle 100 and require the vehicle to operate in a zero-emissions “EV mode.” In some embodiments, the geographic zone may comprise a low emissions operational requirement that restricts the amounts of pollutants (e.g., NOx, SOx, greenhouse gases, etc.) emitted from the vehicle 100. Such low emissions operational requirements may be enforced via emissions monitoring equipment placed on the route and may restrict the types of fuels that may be used by the fuel fed engine 112 of the vehicle. In some embodiments, the geographic zone may comprise a low noise operational requirement. Such low noise operational requirements may restrict the use of the fuel fed engine 112 of the vehicle 100. In some embodiments, the low noise operational requirements may be required only during certain predetermined timeframes, such as from 9:00 p.m. to 7:00 a.m. in heavily populated or inhabited areas. Accordingly, many of these operational requirements may restrict or altogether prohibit use of the fuel fed engine 112 or significantly restrict the capacity at which the fuel fed engine 112 can operate. Thus, in such geographic zones, the battery system 116 must have sufficient electrical power stored in the battery packs 118 to make it through the EV zone.

In some embodiments, the geographic zone may require a user-defined operational requirement to maximize the performance of the vehicle 100. In some embodiments, the geographic zone may comprise an operating requirement of operating the vehicle 100 to produce maximum power (e.g., for steep uphill grades) or operating the vehicle 100 to achieve maximum fuel efficiency (e.g., for steep downhill grades or where no other operational requirements are foreseeable on the current route). In some embodiments, a geographic zone may comprise more than one operational requirement, such as any combination of mandatory operational requirements and user-defined operational requirements. In some embodiments, user-defined operational requirements may be input through the user interface 135.

In some embodiments, the control system 130 and/or the cloud computing system 140 may analyze the route, including the vehicle data and external data and create a rule-based operational requirement for the vehicle 100. In some embodiments, the control system 130 and/or the cloud computing system 140 may identify an environmentally sensitive geographic zone and automatically create low or zero emissions and/or low noise operational requirements for these geographic zones. Such environmentally sensitive geographic zones may include national or state parks, wildlife preserves, small towns having a major highway running through, and/or densely populated areas. In some embodiments, the control system 130 and/or the cloud computing system 140 may identify one or more heavy terrain geographic zones and automatically create maximum power operational requirements for these geographic zones. Such heavy terrain geographic zones may include mountainous regions with exceptionally hilly terrain. In some embodiments, the control system 130 and/or the cloud computing system 140 may create time-based operational requirements that restricts or altogether prohibits operation of the fuel fed engine 112 during certain hours, such as at night in heavily populated areas.

Further, in some embodiments requiring more than one operational requirement, a priority may be assigned to the operational requirements. In some embodiments, the vehicle 100 may prioritize mandatory operational requirements over user-defined or rule-based operational requirements. In an example, if the vehicle 100 is travelling through a geographic zone on a route that requires low noise during night, and the driver required a user-defined operational requirement of operating the vehicle for maximum power, the control system 130 on the vehicle 100 may prioritize operating the vehicle 100 with low noise over operating the vehicle 100 for maximum power and thus may restrict the output of the fuel fed engine 112. In another example, if the driver requires the vehicle 100 to operate in the zero emissions “EV mode” but difficult terrain requires operation of the fuel fed engine 112, then the control system 130 on the vehicle 100 may automatically switch the operating configuration to operate with reduced emissions or low noise. Accordingly, it will be appreciated that the vehicle 100 may autonomously operate in the most environmentally friendly mode while maximizing performance.

In response to determining that a geographic zone having an operational requirement exists on the route of the vehicle 100, whether in real time or prior to the vehicle 100 embarking on the route, the control system 130 and/or the cloud computing system 140 may create a preparation “prep” zone that surrounds the geographic zone having the operational requirement. Creation of the prep zone may be based on vehicle data and/or external data, including the current route or projected route of the vehicle 100, the speed of the vehicle 100, distance of the vehicle 100 from the geographic zone having the operational requirement, terrain of the route leading up to the geographic zone having the operational requirement, traffic conditions on the route leading up to the geographic zone having the operational requirement, weather conditions on the route leading up to the geographic zone having the operational requirement, the size, distance, road conditions, weather, terrain, traffic and speed requirements of the geographic zone having the operational requirement, the weight of the vehicle 100, the load of the vehicle 100, the battery system capacity in the vehicle 100, or any combination of these and other factors. In some embodiments, creation of the prep zone may account for not only the specific route of the vehicle 100 but any other potential routes or detours that the vehicle 100 may take to enter the geographic zone having the operational requirement.

The prep zone defines when the vehicle 100 needs to begin charging the battery system 116 based on the current trajectory of the vehicle 100 along the route to achieve a predetermined or desired minimum state of charge (SoC) for the battery system 116 prior to the vehicle 100 entering the geographic zone having the operational requirement. Accordingly, the control system 130 and/or the cloud computing system 140 may determine a prep zone powertrain configuration for the vehicle 100. The prep zone powertrain configuration may generally include specific operating instructions for the vehicle 100 in the prep zone that ensure the battery system 116 achieves the required minimum SoC prior to the vehicle 100 entering the geographic zone having the operational requirement. The minimum SoC may also ensure sufficient electrical power from the battery system 116 is available to power the vehicle 100 through the geographic zone having the operational requirement and remain in compliance with the operational requirement. In some embodiments, the prep zone powertrain configuration may be based on the size, distance, road conditions, weather, terrain, traffic and speed requirements of the prep zone, the weight of the vehicle 100, the load of the vehicle 100, the battery system capacity in the vehicle 100, or any combination of these and other factors. Accordingly, when the vehicle 100 enters the prep zone, the control system 130 may execute instructions to operate the vehicle 100 in accordance with the prep zone powertrain configuration.

Prior to entering the geographic zone having the operational requirement, the control system 130 and/or the cloud computing system 140 may determine a geographic zone powertrain configuration for the vehicle 100. The geographic zone powertrain configuration may generally include specific operating instructions for the vehicle 100 to operate through the geographic zone having the operational requirement and remain in compliance with the operational requirement in the geographic zone. For example, in a geographic zone comprising a zero emissions requirement, the geographic zone powertrain configuration may include instructions to prevent the fuel fed engine 112 from operation and additional instructions to selectively supply an amount of electrical power to the second M/G 120 to propel the vehicle 100 through the geographic zone. In a geographic zone comprising a maximum power requirement, the geographic zone powertrain configuration may include instructions to operate the fuel fed engine 112 continuously or when the SoC of the battery system 116 drops below a predetermined elevated threshold (e.g., 50%, 60%, 70%, or even 80% depending on the terrain). In some embodiments, the geographic zone powertrain configuration may be based on the size, distance, road conditions, weather, terrain, traffic and speed requirements of the geographic zone, the weight of the vehicle 100, the load of the vehicle 100, the battery system capacity in the vehicle 100, or any combination of these and other factors.

In some embodiments, the geographic zone powertrain configuration for the vehicle 100 may be determined upon identification of the geographic zone having the operational requirement, simultaneously with determining the prep zone configuration, or upon entering the prep zone. Accordingly, when the vehicle 100 enters the geographic zone having the operational requirement, the control system 130 may execute instructions to operate the vehicle 100 in accordance with the geographic zone powertrain configuration to ensure compliance with the operational requirement in the geographic zone. Upon exiting the geographic zone having the operational requirement, the control system 130 may resume normal operation of the vehicle 100 and continue the “look-ahead” route planning and powertrain configuration preparation based on the route or anticipated route of the vehicle 100.

As stated, the geographic zone identification, prep zone powertrain configuration creation, and geographic zone powertrain configuration creation may be performed by the control system 130 and/or cloud computing system 140. It will be appreciated that in embodiments where the cloud computing system 140 performs the geographic zone identification, prep zone powertrain configuration creation, and/or geographic zone powertrain configuration creation, the cloud computing system 140 may communicate the prep zone powertrain configuration and the geographic zone powertrain configuration, amongst other information associated with the geographic zone having the operational requirement, to the control system 130. This allows the control system 130 to implement the powertrain configurations to control the vehicle 100 in accordance with each of the powertrain configurations. In some embodiments, the control system 130 and/or the cloud computing system 140 may continuously communicate to update the powertrain configurations based on changes in the vehicle data, the external data, or a combination thereof. Further, in some embodiments, the control system 130 and/or the cloud computing system 140 may continuously communicate to update the powertrain configurations based on changes in the route or other characteristic of the vehicle 100.

The geographic zone identification and preparation system (“geo zone system”) disclosed herein provides advanced vehicle analytics, which allow the control system 130 to operate the vehicle 100 to achieve maximize fuel efficiency and/or power while reserving or generating an optimal SoC in the battery system 116 for operating the vehicle 100 through geographic zones having operational requirements and maintaining compliance with the operational requirement. Accordingly, by executing a “look ahead” algorithm that analyzes the route of the vehicle 100 and identifies geographic zones having an operational requirement along the route, the vehicle 100 may operate to achieve maximum fuel efficiency over portions of a route where no operational requirements exist, while reserving or generating appropriate electrical power in the battery system 116 through prep zones for operation in the geographic zones having operational requirements. Because the operation of the vehicle 100 in the EV mode and others is limited by the SoC of the battery system 116, the advanced “look-ahead” features of the geo zone system disclosed herein enable the vehicle 100 to plan ahead and provide a sufficient state of charge (SoC) for the battery system 116 for all portions of the route. This allows the vehicle 100 to operate efficiently over all portions of the route while complying with any operational requirements without experiencing range anxiety or loss of power.

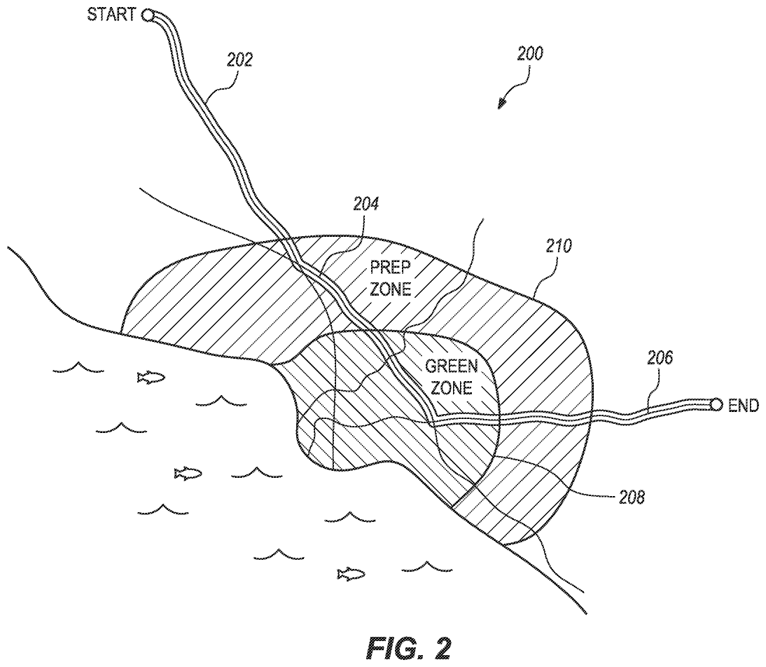

FIG. 2 shows a schematic diagram of an example route 200 of a vehicle 100 through a geographic zone 208 having an operational requirement according to an embodiment of the disclosure. In the example shown, the route 200 of the vehicle 100 includes a Route Start (“Start”), a first road segment 202, a second road segment 204, a third road segment 206, and a Route End (“End”). In operation, the control system 130 and/or the cloud computing system 140 may be configured to analyze the route 200 and determine whether a geographic zone 208 having an operational requirement exists on the route 200 of the vehicle 100. This may be performed while travelling on road segment 202 or prior to embarking on the route 200. In the example shown, the geographic zone 208 (“EV zone” or “green zone”) comprises a zero emissions operational requirement that extends over portions of the second road segment 204 and the third road segment 206 of the route 200. This operational requirement demands that electric vehicles operate in an EV only mode while producing no emissions.

In response to identifying the geographic zone 208 on the route 200 that has the zero emissions operational requirement, the control system 130 and/or the cloud computing system 140 may create a prep zone 210 that surrounds the geographic zone 208. The prep zone 210 defines when the vehicle 100 needs to begin charging the battery system 116 based on the current trajectory of the vehicle 100 along the route 200 to achieve a desired minimum state of charge (SoC) for the battery system 116 prior to the vehicle 100 entering the geographic zone 208 having the zero emissions operational requirement.

The control system 130 and/or the cloud computing system 140 may determine a prep zone powertrain configuration for the vehicle 100. The prep zone powertrain configuration may generally include specific operating instructions for the vehicle 100 in the prep zone 210 that ensure the battery system 116 achieves the required minimum SoC prior to the vehicle 100 entering the geographic zone 208 having the zero emissions operational requirement. The minimum SoC may ensure sufficient electrical power from the battery system 116 is available to power the vehicle 100 through the geographic zone 208 and remain in compliance with the zero emissions operational requirement. In some embodiments, the prep zone powertrain configuration may be based on the size, distance, road conditions, weather, terrain, traffic and speed requirements of the prep zone 210, the weight of the vehicle 100, the load of the vehicle 100, the battery system capacity in the vehicle 100, or any combination of these and other factors.

In the example shown, the control system 130 or the cloud computing system 140 may determine a minimum SoC for the battery system 116 to be 50% for the geographic zone 208 in clear conditions with no traffic. In other examples, the minimum SoC may be 70% in moderate traffic and 90+% in heavy traffic, adverse weather conditions, or hilly terrain. Accordingly, when the vehicle 100 enters the prep zone 210 along the first road segment 202, the control system 130 may operate the vehicle 100 in accordance with the prep zone powertrain configuration to ensure the battery system 116 of the vehicle 100 achieves the minimum SoC for the battery system 116 of the vehicle 100.

Prior to entering the geographic zone 208 along the second road segment 204, the control system 130 and/or the cloud computing system 140 may determine a geographic zone powertrain configuration for the vehicle 100. The geographic zone powertrain configuration may generally include specific operating instructions for the vehicle 100 to operate through the geographic zone 208 having the zero emissions operational requirement and remain in compliance with the zero emissions operational requirement throughout the geographic zone 208. In the example shown, the geographic zone powertrain configuration may include instructions to prevent the fuel fed engine 112 of the vehicle 100 from operating and additional instructions to selectively supply an amount of electrical power to the second M/G 120 to propel the vehicle 100 through the geographic zone 208 while complying with the zero emissions operational requirement. Upon exiting the geographic zone 208, the control system 130 may resume normal operation of the vehicle 100 along the third road segment 206 and continue the “look-ahead” route planning and powertrain configuration preparation based on the route 200 or anticipated route 200 of the vehicle 100.

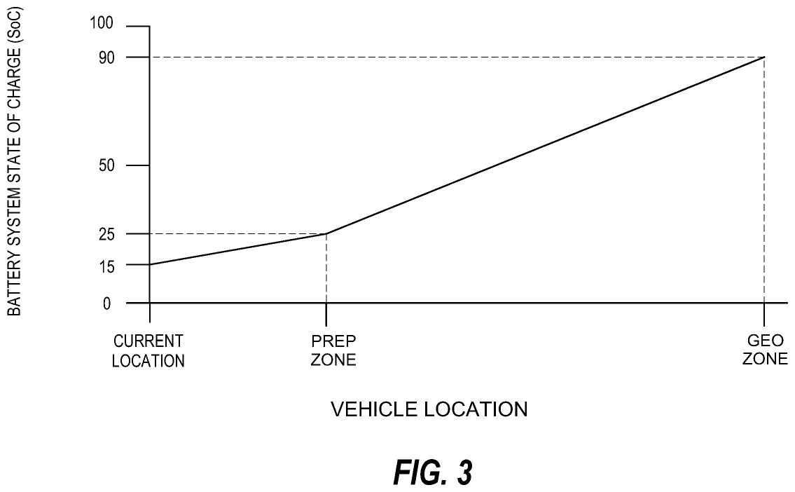

FIG. 3 shows a graph of an example charging strategy for the battery system 116 of the vehicle 100 according to an embodiment of the disclosure. As shown in the depicted example, the vehicle 100 may comprise an SoC of about 15% for the battery system 116 in its current location. According to the current powertrain configuration for the vehicle 100, the control system 130 may anticipate that the battery system 116 may achieve an SoC of about 25% upon entering the prep zone. In analyzing the prep zone, the geographic zone having an operational requirement, and the characteristics of the route and the vehicle 100, the control system 130 may determine that the minimum SoC required to operate through the identified geographic zone having the operational requirement may be at least 90%. Accordingly, the control system 130 may implement a prep zone powertrain configuration that ensures the battery system 116 of the vehicle 100 will achieve the 90% SoC prior to entering the geographic zone. In some embodiments, the control system 130 may implement a substantially linear charging rate through the prep zone to ensure the most efficient charging of the battery system 116 and operation of the vehicle 100. Thus, it will be appreciated that the control system 130 may analyze the terrain and other aspects of the route and the characteristics of the vehicle 100 and create a charging strategy for the battery system 116 that maximizes efficiency and/or performance while achieving the required minimum SoC prior to entering the geographic zone having the operational requirement.

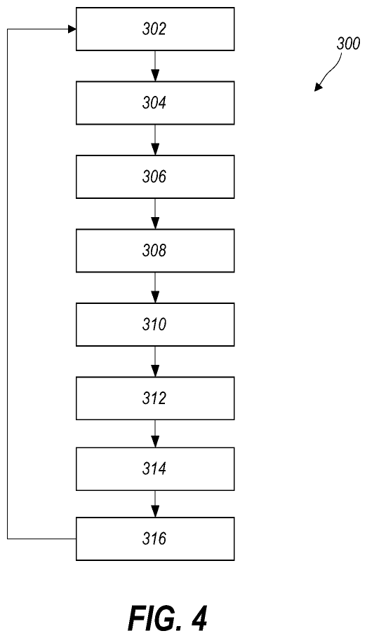

FIG. 4 shows a flowchart of a method of operating a vehicle according to an embodiment of the disclosure. FIG. 4 and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In the example of FIG. 4, a method 300 may begin at block 302 by providing a vehicle 100 comprising a fuel fed engine 112 coupled to a first motor/generator (M/G) 114 and configured to burn one or more fuels to provide rotational power to the first M/G 114 to generate electrical power, a battery system 116 coupled to the first M/G 114 and configured to receive and store electrical power generated by the first M/G 114, a second M/G 120 coupled to the battery system 116 and one or more drive axles 108, 110 and configured to receive electrical power from the battery system 116 to provide a motive torque through the one or more drive axles 108, 110 to propel the vehicle 100 over a route, and a control system 130. In some embodiments, the second M/G 120 may also be driven by the one or more drive axles 108, 110 in a regenerative braking mode to generate electrical power to charge the battery system 116.

The method 300 may continue at block 304 by determining a route for the vehicle 100. In some embodiments, the route may be input by a user through the user interface 135 in the vehicle 100.

The method 300 may continue at block 306 by determining whether a geographic zone 208 having an operational requirement exists on the route of the vehicle 100. In some embodiments, the geographic zone 208 may require a mandatory operational requirement that may be imposed by a municipality or other governing body, a user-defined operational requirement to maximize the performance of the vehicle 100, or a rule-based operational requirement that balances the demand for performance of the vehicle 100. In some embodiments, the determination of whether a geographic zone 208 having an operational requirement exists on the route of the vehicle 100 may occur as the vehicle 100 travels over the route (e.g., in response to route changes, exits, detours, etc.). In some embodiments, the determination of whether a geographic zone 208 having an operational requirement exists on the route may occur prior to the vehicle 100 beginning to travel over the route.

The method 300 may continue at block 308 by creating a prep zone 210 that surrounds the geographic zone 208 in response to determining that a geographic zone 208 having an operational requirement exists on the route of the vehicle 100. Creation of the prep zone 210 may be based on vehicle data and/or external data, including the current route or projected route of the vehicle 100, the speed of the vehicle 100, distance of the vehicle 100 from the geographic zone 208 having the operational requirement, terrain of the route leading up to the geographic zone 208 having the operational requirement, traffic conditions on the route leading up to the geographic zone 208 having the operational requirement, weather conditions on the route leading up to the geographic zone 208 having the operational requirement, the size, distance, road conditions, weather, terrain, traffic and speed requirements of the geographic zone 208 having the operational requirement, the weight of the vehicle 100, the load of the vehicle 100, the battery system capacity in the vehicle 100, or any combination of these and other factors. The prep zone 210 defines when the vehicle 100 needs to begin charging the battery system 116 based on the current trajectory of the vehicle 100 along the route to achieve a desired minimum state of charge (SoC) for the battery system 116 prior to the vehicle 100 entering the geographic zone 208 having the operational requirement.

The method 300 may continue at block 310 by creating a prep zone powertrain configuration for the vehicle 100. The prep zone powertrain configuration may generally include specific operating instructions for the vehicle 100 in the prep zone 210 that ensure the battery system 116 achieves the required minimum SoC prior to the vehicle 100 entering the geographic zone 208 having the operational requirement. The minimum SoC may also ensure sufficient electrical power from the battery system 116 is available to power the vehicle 100 through the geographic zone 208 having the operational requirement and remain in compliance with the operational requirement. In some embodiments, the prep zone powertrain configuration may be based on the size, distance, road conditions, weather, terrain, traffic, and speed requirements of the prep zone 210, the weight of the vehicle 100, the load of the vehicle 100, the battery system capacity in the vehicle 100, or any combination of these and other factors.

The method 300 may continue at block 312 by operating the vehicle 100 through the prep zone 210 in accordance with the prep zone powertrain configuration. In some embodiments, operating the vehicle 100 through the prep zone 210 in accordance with the prep zone powertrain configuration may ensure sufficient electrical power from the battery system 116 is available to power the vehicle 100 through the geographic zone 208 having the operational requirement and remain in compliance with the operational requirement.

The method 300 may continue at block 314 by creating a geographic zone powertrain configuration for the vehicle 100. The geographic zone powertrain configuration may generally include specific operating instructions for the vehicle 100 to operate through the geographic zone 208 having the operational requirement and remain in compliance with the operational requirement in the geographic zone 208. In some embodiments, the geographic zone powertrain configuration may be based on the size, distance, road conditions, weather, terrain, traffic, and speed requirements of the geographic zone 208, the weight of the vehicle 100, the load of the vehicle 100, the battery system capacity in the vehicle 100, or any combination of these and other factors. In some embodiments, the geographic zone powertrain configuration for the vehicle 100 may be determined upon identification of the geographic zone 208 having the operational requirement, simultaneously with determining the prep zone configuration, or upon entering the prep zone 210.

The method 300 may continue at block 316 by operating the vehicle 100 through the geographic zone 208 in compliance with the geographic zone powertrain configuration. In some embodiments, operating the vehicle 100 through the geographic zone 208 having the operational requirement may ensure compliance with the operational requirement in the geographic zone 208. Further, in some embodiments, operating the vehicle 100 through the geographic zone 208 having the operational requirement may ensure the vehicle 100 complies with the operational requirement through the geographic zone 208 without having range anxiety through the geographic zone 208.

Upon exiting the geographic zone 208 having the operational requirement, the control system 130 may resume normal operation of the vehicle 100 and continue the “look-ahead” route planning and powertrain configuration preparation based on the route or anticipated route of the vehicle 100. Accordingly, the method 300 may continuously repeat as the vehicle 100 travels over a route in response to changes in the route and/or in response to changes in the conditions in the vehicle data, the external data, or a combination thereof.

Embodiments of a vehicle 100, a geographic zone preparation system of a vehicle 100, and/or method 300 of operating a vehicle 100 may comprise one or more of the following embodiments:

Embodiment 1. A vehicle comprising: a fuel fed engine coupled to a first motor/generator (M/G) and configured to burn one or more fuels to provide rotational power to the first M/G to generate electrical power; a battery system coupled to the first M/G and configured to receive and store electrical power generated by the first M/G; a second M/G coupled to the battery system and one or more drive axles and configured to receive electrical power from the battery system to provide a motive torque through the one or more drive axles to propel the vehicle over a route; and a control system that executes instructions to: determine whether a geographic zone having an operational requirement exists on the route of the vehicle; create a prep zone that surrounds the geographic zone in response to determining that a geographic zone having an operational requirement exists on the route; create a prep zone powertrain configuration for the vehicle; and operate the vehicle through the prep zone in accordance with the prep zone powertrain configuration to provide the battery system with a predetermined state of charge (SoC) prior to the vehicle entering the geographic zone.

Embodiment 2. The vehicle of embodiment 1, wherein the second M/G is configured to generate electrical power through the one or more drive axles in a regenerative braking mode to charge the battery system.

Embodiment 3. The vehicle of any of embodiments 1 to 2, wherein the control system comprises a main control unit, a drive processing unit, a gateway therebetween, one or more databases configured to receive and store vehicle data, and a user interface.

Embodiment 4. The vehicle of embodiment 3, wherein the vehicle data comprises a current location of the vehicle, a speed of the vehicle, load information of the vehicle, a planned destination for the vehicle, a route of the vehicle, a state of charge (SoC) of the battery system of the vehicle, terrain data, a grade of road on which the vehicle is travelling, geographic information associated with the route of the vehicle, ordinances or regulations associated with the route of the vehicle, a fuel level, or any combination thereof.

Embodiment 5. The vehicle of any of embodiments 1 to 4, wherein the control system is connected in wireless communication with a cloud computing system and configured to receive external data from the cloud computing system for use locally on the vehicle.

Embodiment 6. The vehicle of embodiment 5, wherein the external data comprises a grade of each portion of the route of the vehicle, road conditions of the route of the vehicle, weather data associated with the route of the vehicle, geographic information associated with the route of the vehicle, ordinances or regulations associated with the route of the vehicle, traffic information associated with the route of the vehicle, or any combination thereof.

Embodiment 7. The vehicle of any of embodiments 3 to 6, wherein the determination of whether a geographic zone having an operational requirement exists on the route is based on the vehicle data, the external data, or a combination thereof.

Embodiment 8. The vehicle of any of embodiments 1 to 7, wherein the determination of whether a geographic zone having an operational requirement exists on the route occurs as the vehicle travels over a road segment or prior to the vehicle beginning to travel over the route.

Embodiment 9. The vehicle of any of embodiments 1 to 8, wherein the operational requirement comprises a zero emissions operational requirement, a low emissions operational requirement that restricts the amount of pollutants emitted from the vehicle, a low noise operational requirement, a user-defined operational requirement that maximizes power performance or fuel efficiency of the vehicle, a time-based operational requirement, an operational requirement that restricts the use of the fuel fed engine, or a combination thereof.

Embodiment 10. The vehicle of embodiment 9, wherein the route, the user-defined operational requirement, or a combination thereof is input into a user interface of the control system.

Embodiment 11. The vehicle of any of embodiments 1 to 10, wherein the control system identifies an environmentally sensitive geographic zone and automatically creates a low or zero emissions operational requirement, a low noise operational requirement, or a combination thereof for the geographic zone.

Embodiment 12. The vehicle of any of embodiments 1 to 11, wherein the control system identifies a heavy terrain geographic zone and automatically creates a maximum power operational requirement for the geographic zone.

Embodiment 13. The vehicle of any of embodiments 1 to 12, wherein the control system identifies a heavily populated geographic zone and automatically creates a time-based operational requirement that restricts operation of the fuel fed engine during a predetermined timeframe in the geographic zone.

Embodiment 14. The vehicle of any of embodiments 1 to 13, wherein the control system assigns a priority to the operational requirements where the geographic zone comprises more than one operational requirement.

Embodiment 15. The vehicle of embodiment 14, wherein the control system prioritizes mandatory operational requirements over user-defined or rule-based operational requirements.

Embodiment 16. The vehicle of any of embodiments 1 to 15, wherein creation of the prep zone is based on the current route or projected route of the vehicle, a speed of the vehicle, a distance of the vehicle from the geographic zone having the operational requirement, terrain of the route leading up to the geographic zone having the operational requirement, traffic conditions on the route leading up to the geographic zone having the operational requirement, weather conditions on the route leading up to the geographic zone having the operational requirement, the size, distance, road conditions, weather, terrain, traffic or speed requirements of the geographic zone having the operational requirement, the weight of the vehicle, the load of the vehicle, the battery system capacity in the vehicle, or any combination thereof.

Embodiment 17. The vehicle of any of embodiments 1 to 16, wherein the prep zone defines when the vehicle needs to begin charging the battery system based on the current trajectory of the vehicle along the route to achieve a desired minimum state of charge (SoC) for the battery system prior to the vehicle entering the geographic zone having the operational requirement.

Embodiment 18. The vehicle of embodiment 17, wherein the control system determines a prep zone powertrain configuration for the vehicle comprising specific operating instructions for the vehicle in the prep zone that ensure the battery system achieves the minimum SoC prior to the vehicle entering the geographic zone having the operational requirement.

Embodiment 19. The vehicle of any of embodiments 17 to 18, wherein the minimum SoC ensures sufficient electrical power from the battery system is available to power the vehicle through the geographic zone having the operational requirement and remain in compliance with the operational requirement.

Embodiment 20. The vehicle of any of embodiments 18 to 19, wherein the prep zone powertrain configuration is based on the size, distance, road conditions, weather, terrain, traffic and speed requirements of the prep zone, the weight of the vehicle, the load of the vehicle, the battery system capacity in the vehicle, or any combination thereof.

Embodiment 21. The vehicle of any of embodiments 18 to 20, wherein the control system executes instructions to operate the vehicle in accordance with the prep zone powertrain configuration upon the vehicle entering the prep zone.

Embodiment 22. The vehicle of any of embodiments 1 to 21, wherein the control system determines a geographic zone powertrain configuration for the vehicle comprising specific operating instructions for the vehicle to operate through the geographic zone having the operational requirement and remain in compliance with the operational requirement in the geographic zone.

Embodiment 23. The vehicle of embodiment 22, wherein the geographic zone powertrain configuration is based on the size, distance, road conditions, weather, terrain, traffic and speed requirements of the geographic zone, the weight of the vehicle, the load of the vehicle, the battery system capacity in the vehicle, or any combination thereof.

Embodiment 24. The vehicle of any of embodiments 22 to 23, wherein the control system executes instructions to operate the vehicle in accordance with the geographic zone powertrain configuration upon entering the geographic zone having the operational requirement.

Embodiment 25. A method of operating a vehicle, comprising: providing a vehicle comprising a fuel fed engine coupled to a first motor/generator (M/G) and configured to burn one or more fuels to provide rotational power to the first M/G to generate electrical power, a battery system coupled to the first M/G and configured to receive and store electrical power generated by the first M/G, a second M/G coupled to the battery system and one or more drive axles and configured to receive electrical power from the battery system to provide a motive torque through the one or more drive axles to propel the vehicle over a route, and a control system; determining a route for the vehicle; determining whether a geographic zone having an operational requirement exists on the route; creating a prep zone that surrounds the geographic zone in response to determining that a geographic zone having an operational requirement exists on the route; creating a prep zone powertrain configuration for the vehicle; operating the vehicle through the prep zone in accordance with the prep zone powertrain configuration to provide the battery system with a predetermined state of charge (SoC) prior to the vehicle entering the geographic zone; creating a geographic zone powertrain configuration for the vehicle; and operating the vehicle through the geographic zone in compliance with the geographic zone powertrain configuration.

Embodiment 26. The method of embodiment 25, further comprising: generating electrical power to charge the battery system by operating the second M/G in a regenerative braking mode to recover rotational energy from the one or more drive axles.

Embodiment 27. The method of any of embodiments 25 to 26, wherein the route is input by a user through a user interface in the vehicle.

Embodiment 28. The method of any of embodiments 25 to 27, wherein determining whether a geographic zone having an operational requirement exists on the route of the vehicle occurs as the vehicle travels over the route.

Embodiment 29. The method of any of embodiments 25 to 28, wherein the operational requirement comprises a zero emissions operational requirement, a low emissions operational requirement that restricts the amount of pollutants emitted from the vehicle, a low noise operational requirement, a user-defined operational requirement that maximizes power performance or fuel efficiency of the vehicle, a time-based operational requirement, an operational requirement that restricts the use of the fuel fed engine, or a combination thereof.

Embodiment 30. The method of any of embodiments 25 to 29, further comprising: identifying an environmentally sensitive geographic zone and automatically creating a low or zero emissions operational requirement, a low noise operational requirement, or a combination thereof for the geographic zone.

Embodiment 31. The method of any of embodiments 25 to 30, further comprising: identifying a heavy terrain geographic zone and automatically creating a maximum power operational requirement for the geographic zone.

Embodiment 32. The method of any of embodiments 25 to 31, further comprising: identifying a heavily populated geographic zone and automatically creating a time-based operational requirement that restricts operation of the fuel fed engine during a predetermined timeframe in the geographic zone.

Embodiment 33. The method of any of embodiments 25 to 32, further comprising: assigning a priority to the operational requirements where the geographic zone comprises more than one operational requirement; and prioritizing mandatory operational requirements over user-defined or rule-based operational requirements.

Embodiment 34. The method of any of embodiments 25 to 33, wherein creating the prep zone is based on the current route or projected route of the vehicle, a speed of the vehicle, a distance of the vehicle from the geographic zone having the operational requirement, terrain of the route leading up to the geographic zone having the operational requirement, traffic conditions on the route leading up to the geographic zone having the operational requirement, weather conditions on the route leading up to the geographic zone having the operational requirement, the size, distance, road conditions, weather, terrain, traffic or speed requirements of the geographic zone having the operational requirement, the weight of the vehicle, the load of the vehicle, the battery system capacity in the vehicle, or any combination thereof.

Embodiment 35. The method of any of embodiments 25 to 34, wherein the prep zone defines when the vehicle needs to begin charging the battery system based on the current trajectory of the vehicle along the route to achieve a desired minimum state of charge (SoC) for the battery system prior to the vehicle entering the geographic zone having the operational requirement.

Embodiment 36. The method of embodiment 35, wherein the control system determines a prep zone powertrain configuration for the vehicle comprising specific operating instructions for the vehicle in the prep zone that ensure the battery system achieves the minimum SoC prior to the vehicle entering the geographic zone having the operational requirement.

Embodiment 37. The method of any of embodiments 35 to 36, wherein the minimum SoC ensures sufficient electrical power from the battery system is available to power the vehicle through the geographic zone having the operational requirement and remain in compliance with the operational requirement.

Embodiment 38. The method of any of embodiments 36 to 37, wherein the prep zone powertrain configuration is based on the size, distance, road conditions, weather, terrain, traffic and speed requirements of the prep zone, the weight of the vehicle, the load of the vehicle, the battery system capacity in the vehicle, or any combination thereof.

Embodiment 39. The method of any of embodiments 25 to 38, further comprising: operating the vehicle in accordance with the prep zone powertrain configuration upon the vehicle entering the prep zone.

Embodiment 40. The method of any of embodiments 25 to 39, further comprising: determining a geographic zone powertrain configuration for the vehicle comprising specific operating instructions for the vehicle to operate through the geographic zone having the operational requirement and remain in compliance with the operational requirement in the geographic zone.

Embodiment 41. The method of embodiment 40, wherein the geographic zone powertrain configuration is based on the size, distance, road conditions, weather, terrain, traffic and speed requirements of the geographic zone, the weight of the vehicle, the load of the vehicle, the battery system capacity in the vehicle, or any combination thereof.

Embodiment 42. The method of any of embodiments 40 to 41, further comprising: operating the vehicle in accordance with the geographic zone powertrain configuration upon entering the geographic zone having the operational requirement.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A vehicle comprising:
a fuel fed engine coupled to a first motor/generator (M/G) and configured to burn one or more fuels to provide power to the first M/G to generate electrical power;
a battery system coupled to the first M/G and configured to receive and store electrical power generated by the first M/G;
a second M/G coupled to the battery system and one or more drive axles and configured to receive electrical power from the battery system to provide a motive torque through the one or more drive axles to propel the vehicle over a route; and
a control system configured to:
determine whether a geographic zone having an operational requirement exists on the route of the vehicle;
create a prep zone that surrounds the geographic zone in response to determining that a geographic zone having an operational requirement exists on the route;
create a prep zone powertrain configuration for the vehicle; and
operate the vehicle through the prep zone in accordance with the prep zone powertrain configuration to provide the battery system with a predetermined state of charge (SoC) prior to the vehicle entering the geographic zone.

2. The vehicle of claim 1, wherein the second M/G is configured to generate electrical power through the one or more drive axles in a regenerative braking mode to charge the battery system.

3. The vehicle of claim 1, wherein the control system comprises a main control unit, a drive processing unit, a gateway therebetween, one or more databases configured to receive and store vehicle data, and a user interface.

4. The vehicle of claim 3, wherein the vehicle data comprises a current location of the vehicle, a speed of the vehicle, load information of the vehicle, a planned destination for the vehicle, a route of the vehicle, a state of charge (SoC) of the battery system of the vehicle, terrain data, a grade of road on which the vehicle is travelling, geographic information associated with the route of the vehicle, ordinances or regulations associated with the route of the vehicle, a fuel level, or any combination thereof.

5. The vehicle of claim 3, wherein the control system is configured to determine whether a geographic zone having an operational requirement exists on the route based on the vehicle data.

6. The vehicle of claim 1, wherein the control system is connected in wireless communication with a cloud computing system and configured to receive external data from the cloud computing system for use locally on the vehicle.

7. The vehicle of claim 6, wherein the external data comprises a grade of each portion of the route of the vehicle, road conditions of the route of the vehicle, weather data associated with the route of the vehicle, geographic information associated with the route of the vehicle, ordinances or regulations associated with the route of the vehicle, traffic information associated with the route of the vehicle, or any combination thereof.

8. The vehicle of claim 6, wherein the control system is configured to determine whether the geographic zone having an operational requirement exists on the route based on the external data.

9. The vehicle of claim 1, wherein the control system is configured to determine whether the geographic zone having an operational requirement exists on the route as the vehicle travels over a road segment or prior to the vehicle beginning to travel over the route.

10. The vehicle of claim 1, wherein the operational requirement comprises a zero emissions operational requirement, a low emissions operational requirement that restricts an amount of pollutants emitted from the vehicle, a low noise operational requirement, a user-defined operational requirement that maximizes power performance or fuel efficiency of the vehicle, a time-based operational requirement, an operational requirement that restricts use of the fuel fed engine, or a combination thereof.

11. The vehicle of claim 10, wherein the control system is configured to receive the route, the user-defined operational requirement, or a combination thereof as input into a user interface of the control system.

12. The vehicle of claim 1, wherein the control system is configured to identify an environmentally sensitive geographic zone and automatically creates a low or zero emissions operational requirement, a low noise operational requirement, or a combination thereof for the geographic zone.

13. The vehicle of claim 1, wherein the control system is configured to identify a heavy terrain geographic zone and automatically creates a maximum power operational requirement for the geographic zone.

14. The vehicle of claim 1, wherein the control system is configured to identify a heavily populated geographic zone and to automatically create a time-based operational requirement that restricts operation of the fuel fed engine during a predetermined timeframe in the geographic zone.

15. The vehicle of claim 1, wherein the control system is configured to assign a priority to each operational requirement among a plurality of operational requirements where the geographic zone comprises the plurality of operational requirements.

16. The vehicle of claim 15, wherein the control system is configured to prioritize mandatory operational requirements over user-defined or rule-based operational requirements.

17. The vehicle of claim 1, wherein the control system is configured to create the prep zone based on a current route or projected route of the vehicle, a speed of the vehicle, a distance of the vehicle from the geographic zone having the operational requirement, terrain of the route leading up to the geographic zone having the operational requirement, traffic conditions on the route leading up to the geographic zone having the operational requirement, weather conditions on the route leading up to the geographic zone having the operational requirement, a size, distance, road conditions, weather, terrain, traffic or speed requirements of the geographic zone having the operational requirement, a weight of the vehicle, a load of the vehicle, a battery system capacity in the vehicle, or any combination thereof.

18. The vehicle of claim 1, wherein the prep zone defines when the vehicle needs to begin charging the battery system based on a current trajectory of the vehicle along the route to achieve a desired minimum state of charge (SoC) for the battery system prior to the vehicle entering the geographic zone having the operational requirement.

19. The vehicle of claim 18, wherein the control system is configured to determine a prep zone powertrain configuration for the vehicle comprising specific operating instructions for the vehicle in the prep zone that ensure the battery system achieves the minimum SoC prior to the vehicle entering the geographic zone having the operational requirement.

20. The vehicle of claim 18, wherein the minimum SoC ensures sufficient electrical power from the battery system is available to power the vehicle through the geographic zone having the operational requirement and remain in compliance with the operational requirement.

21. The vehicle of claim 19, wherein the prep zone powertrain configuration is based on a size, distance, road conditions, weather, terrain, traffic and speed requirements of the prep zone, a weight of the vehicle, a load of the vehicle, a battery system capacity in the vehicle, or any combination thereof.

22. The vehicle of claim 19, wherein the control system is configured to operate the vehicle in accordance with the prep zone powertrain configuration upon the vehicle entering the prep zone.

23. The vehicle of claim 1, wherein the control system is configured to determine a geographic zone powertrain configuration for the vehicle comprising specific operating instructions for the vehicle to operate through the geographic zone having the operational requirement and remain in compliance with the operational requirement in the geographic zone.

24. The vehicle of claim 23, wherein the geographic zone powertrain configuration is based on a size, distance, road conditions, weather, terrain, traffic and speed requirements of the geographic zone, a weight of the vehicle, a load of the vehicle, a battery system capacity in the vehicle, or any combination thereof.

25. The vehicle of claim 23, wherein the control system is configured to operate the vehicle in accordance with the geographic zone powertrain configuration upon entering the geographic zone having the operational requirement.

26. A method of operating a vehicle, comprising:
providing a vehicle comprising a fuel fed engine coupled to a first motor/generator (M/G) and configured to burn one or more fuels to provide power to the first M/G to generate electrical power, a battery system coupled to the first M/G and configured to receive and store electrical power generated by the first M/G, a second M/G coupled to the battery system and one or more drive axles and configured to receive electrical power from the battery system to provide a motive torque through the one or more drive axles to propel the vehicle over a route, and a control system;
determining a route for the vehicle;
determining whether a geographic zone having an operational requirement exists on the route;
creating a prep zone that surrounds the geographic zone in response to determining that a geographic zone having an operational requirement exists on the route;
creating a prep zone powertrain configuration for the vehicle;
operating the vehicle through the prep zone in accordance with the prep zone powertrain configuration to provide the battery system with a predetermined state of charge (SoC) prior to the vehicle entering the geographic zone;
creating a geographic zone powertrain configuration for the vehicle; and
operating the vehicle through the geographic zone in compliance with the geographic zone powertrain configuration.

27. The method of claim 26, further comprising: generating electrical power to charge the battery system by operating the second M/G in a regenerative braking mode to recover rotational energy from the one or more drive axles.

28. The method of claim 26, wherein the route is input by a user through a user interface in the vehicle.

29. The method of claim 26, wherein determining whether a geographic zone having an operational requirement exists on the route of the vehicle occurs as the vehicle travels over the route.

30. The method of claim 26, wherein the operational requirement comprises a zero emissions operational requirement, a low emissions operational requirement that restricts an amount of pollutants emitted from the vehicle, a low noise operational requirement, a user-defined operational requirement that maximizes power performance or fuel efficiency of the vehicle, a time-based operational requirement, an operational requirement that restricts a use of the fuel fed engine, or a combination thereof.

31. The method of claim 26, further comprising: identifying an environmentally sensitive geographic zone and automatically creating a low or zero emissions operational requirement, a low noise operational requirement, or a combination thereof for the geographic zone.

32. The method of claim 26, further comprising: identifying a heavy terrain geographic zone and automatically creating a maximum power operational requirement for the geographic zone.

33. The method of claim 26, further comprising: identifying a heavily populated geographic zone and automatically creating a time-based operational requirement that restricts operation of the fuel fed engine during a predetermined timeframe in the geographic zone.

34. The method of claim 26, further comprising: assigning a priority to each operational requirement among a plurality of operational requirements where the geographic zone comprises the plurality of operational requirements; and prioritizing mandatory operational requirements over user-defined or rule-based operational requirements.

35. The method of claim 26, wherein creating the prep zone is based on a current route or projected route of the vehicle, a speed of the vehicle, a distance of the vehicle from the geographic zone having the operational requirement, terrain of the route leading up to the geographic zone having the operational requirement, traffic conditions on the route leading up to the geographic zone having the operational requirement, weather conditions on the route leading up to the geographic zone having the operational requirement, a size, distance, road conditions, weather, terrain, traffic or speed requirements of the geographic zone having the operational requirement, a weight of the vehicle, a load of the vehicle, a battery system capacity in the vehicle, or any combination thereof.

36. The method of claim 26, wherein the prep zone defines when the vehicle needs to begin charging the battery system based on a current trajectory of the vehicle along the route to achieve a desired minimum state of charge (SoC) for the battery system prior to the vehicle entering the geographic zone having the operational requirement.

37. The method of claim 36, wherein the control system determines a prep zone powertrain configuration for the vehicle comprising specific operating instructions for the vehicle in the prep zone that ensure the battery system achieves the minimum SoC prior to the vehicle entering the geographic zone having the operational requirement.

38. The method of claim 36, wherein the minimum SoC ensures sufficient electrical power from the battery system is available to power the vehicle through the geographic zone having the operational requirement and remain in compliance with the operational requirement.

39. The method of claim 37, wherein the prep zone powertrain configuration is based on a size, distance, road conditions, weather, terrain, traffic and speed requirements of the prep zone, a weight of the vehicle, a load of the vehicle, a battery system capacity in the vehicle, or any combination thereof.

40. The method of claim 26, further comprising: operating the vehicle in accordance with the prep zone powertrain configuration upon the vehicle entering the prep zone.

41. The method of claim 26, further comprising: determining a geographic zone powertrain configuration for the vehicle comprising specific operating instructions for the vehicle to operate through the geographic zone having the operational requirement and remain in compliance with the operational requirement in the geographic zone.

42. The method of claim 41, wherein the geographic zone powertrain configuration is based on a size, distance, road conditions, weather, terrain, traffic and speed requirements of the geographic zone, a weight of the vehicle, a load of the vehicle, a battery system capacity in the vehicle, or any combination thereof.

43. The method of claim 41, further comprising: operating the vehicle in accordance with the geographic zone powertrain configuration upon entering the geographic zone having the operational requirement.
